(19) United States
(12) Patent Application Publication
(10) Pub. No.: US 2023/0083433 A1
(43) Pub. Date: Mar. 16, 2023

(54) DENTAL TOOLS AND METHODS OF USE

(71) Applicant: ZEST IP HOLDINGS, LLC, Carlsbad, CA (US)

(72) Inventors: Steven PELOTE, Carlsbad, CA (US); Evan COOK, Carlsbad, CA (US); Michael SCHULZKI, Carlsbad, CA (US)

(21) Appl. No.: 17/751,260

(22) Filed: May 23, 2022

Related U.S. Application Data
(60) Provisional application No. 63/244,601, filed on Sep. 15, 2021.

(51) Int. Cl. A61C 8/00; B25B 27/00

(52) U.S. Cl. CPC A61C 8/0089; B25B 27/0028; A61C 8/0054

(57) ABSTRACT

Dental tools and methods for at least one of seating, insertion and removal of one or more components of dental attachment assemblies are described herein. The dental tools comprise an elongate member, an expandable grabber positioned around at least a portion of the elongate member, and an adjustment mechanism. The elongate member comprises an expander, which can have different widths or diameters along its length such that an adjustment of a position of the expandable grabber relative to the elongate member via the adjustment mechanism adjusts a width or diameter of at least a portion, preferably an end portion, of the expandable grabber.

### CROSS-REFERENCE TO RELATED APPLICATIONS

This application claims priority to U.S. patent application No. 63/244,601, filed on Sep. 15, 2021. These and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### BACKGROUND

### Field of the Invention

Devices and methods provided herein relate to a dental tool for seating and removing components of a dental attachment assembly or system.

### Description of the Related Art

Some known dental attachment assemblies may comprise an abutment member for attachment to a tooth root, implant, adjacent tooth, or bar, and a retention member for engagement in a cap secured in a dental appliance, such as a full denture, overdenture, partial denture, or the like. Exemplary dental attachment assemblies are described in, for example, U.S. Pat. Nos. 6,032,219, 6,981,871, 9,033,709, 9,452,029 and 9,486,300. All references, including publications, patent applications, and patents, cited herein are hereby incorporated by reference to the same extent as if each reference were individually and specifically indicated to be incorporated by reference and were set forth in its entirety herein.

Some dental tools are known, including tools that may be used for seating and removing retention members from caps secured in dental appliances. Some exemplary known dental tools are described in U.S. Pat. Nos. 8,303,306, 10,569,391.

### SUMMARY

It is contemplated that dental tools described herein can advantageously be used to remove retention members without damaging the retention member, which can occur when using earlier known dental tools. It is also contemplated that dental tools described herein can advantageously be used to seat retention members in a cap, and to remove various retention members from a cap, including retention members that may be damaged or wet from use, and have different diameters.

In some embodiments, a dental tool comprises an elongate member, an expandable grabber, and an adjustment mechanism between and coupled to the elongate member and expandable grabber.

The elongate member may include a main body portion that includes a component of the adjustment mechanism (e.g., male and female threads), and an expander. The expander may have different widths or diameters along its length. In some contemplated aspects, the expander may have a uniform diameter along about 80% of its length but include an at least partially tapered end portion. In some contemplated aspects, the expander may have a first portion having a first diameter, a second portion having a second diameter different from the first diameter, and a tapered end portion. The different diameters of the expander may correspond to different internal diameters of an expanding portion of an expandable grabber, and a stop may be formed between the different diameter portions as described in more detail herein. In some aspects, the expander of the elongate member may be removably coupled to the main body portion of the elongate member. For example, the expander may comprise a threaded end that removably engages a threaded recess of the main body portion. In some aspects, the expander portion and the main body portion may comprise a single piece. In some aspects, the expander portion and the main body portion may comprise separate pieces bonded together (e.g., via a weld, an adhesive).

The expandable grabber may include a central opening that extends through the length of the expandable grabber, and that is sized and dimensioned to receive a portion of the elongate member, for example, at least a portion of the expander and a portion of the main body portion. It is contemplated that the expandable grabber may comprise different widths or diameters along its length. It is also contemplated that the opening of the expandable grabber can have varying widths or diameters along its length such that different portions of the opening are sized and dimensioned to secure different components of the elongate member. For example, the expandable grabber can comprise a first and second portion, wherein the first portion has a first internal width (the internal width being the width of opening) that is sized and dimensioned to receive at least a portion of the expander portion. The second portion may have a second internal width different from the first internal width, and be sized and dimensioned to receive a portion of the elongate member that is has a larger diameter than the expander portion (e.g., a portion of the elongate member comprising threads that are a part of the adjustment mechanism). Viewed from another perspective, it is contemplated that the first internal width may be between 100-120% a width of the expander portion, and that the second internal width may be between 100-120% of a width of the threaded portion. In some embodiments, the expandable grabber can comprise a third portion having a third internal width different from the first and second internal widths. The third internal width may be larger than each of the first and second internal widths, and be sized and dimensioned to receive a portion of the main body that is wider than the threaded portion. For example, the third internal width may be 100-120% of a width of the main body portion above the threaded portion. An internal stop may be provided between two or more of the portions that limit an adjustment of the position of the expandable grabber relative to the elongate member.

The adjustment mechanism may be coupled to the elongate member and the expandable grabber, and be configured to adjust a position of expandable grabber relative to the elongate member. For example, the adjustment mechanism may comprise complementary threaded portions, wherein an outer surface of the elongate member includes a first threaded portion, wherein an inner surface of the expandable grabber includes a second threaded portion, and wherein a rotation of the expandable grabber relative to the elongate member adjusts an axial position of the tapered end portion of the expander relative to a first end of the opening, thereby changing the diameter or width of the first end of the opening. However, any suitable adjustment mechanism for moving a position of the expandable grabber relative to the elongate member is contemplated herein.

It is contemplated that the dental tools described herein may comprise an abutment driver removably coupled to an end of the elongate member opposite the expander. In some aspects, the end of the elongate member opposite the expander may comprise a threaded portion that is configured to engage a threaded recess of the abutment driver. The abutment driver may be used to deliver an abutment to a tooth root, implant, adjacent tooth, or bar.

In some aspects, a ball handle or other handle may be provided to, for example, ease insertion of a retention member into a cap secured in a dental appliance by enabling pushing with the palm of a hand and reducing the finger strength required. Such handle can include a recess sized and dimensioned to receive at least a portion of the main body, and be positioned on the tool on an end opposite the grabber and expander. In some aspects, the end of the elongate member opposite the expander may comprise a threaded portion that is configured to engage a threaded recess of the handle. In some aspects, a recess of the handle may be configured to allow the handle to removably couple to an abutment driver.

In some aspects, a dental tool is provided comprising: an elongate member having a first outer surface, a first end and a second end, wherein the first outer surface includes a first threaded portion; an expandable grabber having a second outer surface, an inner surface, a third end, a fourth end, and an opening between the third end and the fourth end, wherein the inner surface comprises a second threaded portion complementary to the first threaded portion of the elongate member; an expander forming the first end of the elongate member and comprising a tapered portion; wherein the opening of the expandable grabber is sized and dimensioned to receive a portion of the elongate member having the first threaded portion and the expander such that the first threaded portion and the second threaded portion are configured to adjustably engage one another; and wherein an adjustment of the second threaded portion relative to the first threaded portion adjusts a position of the expander relative to the first end of the expandable grabber, and a width of the third end of the expandable grabber.

The second end of the elongate member can comprise an insertion tool end, and the elongate member can comprise a polygonal handle engaging portion between the first end and the second end. The insertion tool end can comprise one or more projections, including for example, a slotted ring-shaped projection made of a rubber, a silicone, a metal, a plastic, or any other suitable material(s). The dental tool can further comprise a handle having a first open end and a cavity sized and dimensioned to receive at least a portion of the handle engaging portion and the insertion tool end. In some aspects, the elongate member can be removed from the handle, rotated 180 degrees, and the cavity can be sized and dimensioned to receive at least a portion of the handle engaging portion and the first end or expander. At least one of an open end of the handle and a portion of the cavity of the handle can comprise a polygonal shape corresponding to a polygonal shape of the polygonal handle engaging portion.

In some embodiments, a dental tool is provided comprising a handle, an elongate member coupled to the handle, the elongate member having a first side portion, wherein the first side portion comprises a protruding ring, and an expander having a tapered portion, an expandable grabber having an outer surface, an inner surface, a first end, a second end, and an opening between the first end and second end, wherein the opening comprises a first recessed groove and a second recessed groove, wherein the opening of the expandable grabber is sized and dimensioned to receive a portion of the elongate member having the protruding ring and the expander, and wherein the expandable grabber is configured to be pulled away from handle and pushed towards the handle, wherein the protruding ring is configured to be seated in the first recessed groove before the expandable grabber is pulled away from handle, and wherein the protruding ring is configured to be seated in the second recessed groove after the expandable grabber is pulled away from the handle.

In some aspects, a diameter of the first end of the opening can be adjusted based on a push or pull of the expandable grabber relative to the handle. In some aspects, the opening can comprise a non-recessed portion between the first recessed groove and the second recessed groove, and wherein the non-recessed portion of the opening has a smaller diameter than each of the first recessed groove and the second recessed groove. In some aspects, the protruding ring can be configured to repeatedly compress and return to its original shape. In some aspects, the protruding ring can comprise an o-ring seated in a recessed groove of the elongate member. In some aspects, the protruding ring can be fixed. In some aspects, the protruding ring can be removable.

Other advantages and benefits of the disclosed assemblies, components and methods will be apparent to one of ordinary skill with a review of the following detailed description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a perspective view of a dental tool according to an embodiment;

FIG. 1B is a cross-sectional view of the expandable grabber and expander of the dental tool of FIG. 1;

FIG. 2A is a perspective view of another dental tool according to an embodiment;

FIG. 2B is a side elevation view of the dental tool of FIG. 2A including a ball handle;

FIG. 2C is a perspective view of a portion of the expandable grabber of the dental tool of FIG. 2A;

FIG. 2D is a side elevation view of a portion of the expandable grabber and expander of the dental tool of FIG. 2A;

FIG. 2E is another side elevation view of a portion of the expandable grabber and expander of the dental tool of FIG. 2A;

FIG. 2F is an exploded view of a portion of the elongate member and abutment driver of the dental tool of FIG. 2A;

FIG. 3A is a side elevation view of another embodiment of a dental tool;

FIG. 3B is a partial cross-sectional view of the dental tool of FIG. 3A;

FIG. 3C is another side elevation view of the dental tool of FIG. 3A after an adjustment of the expandable grabber relative to the elongate member;

FIG. 3D is a partial cross-sectional view of the dental tool of FIG. 3A after an adjustment as shown in FIG. 3C;

FIG. 3E is a side elevation view of the expandable grabber of FIG. 3A;

FIG. 3F is a cross-sectional view of the expandable grabber of FIG. 3E;

FIG. 3G is a side elevation view of the expander of FIG. 3A;

FIG. 3H is a cross-sectional view of the expander of FIG. 3G;

FIG. 4A is a partial cross-sectional view of another embodiment of a dental tool with a reverse taper expander and in a retracted position;

FIG. 4B is a partial cross-sectional view of the dental tool of FIG. 4A in an expanded position;

FIG. 4C is a side elevation view of the dental tool of FIG. 4A;

FIG. 4D is a side elevation view of the expandable grabber of FIG. 4A;

FIG. 4E is a front elevation view of the expandable grabber of FIG. 4E;

FIG. 4F is a side elevation view of the elongate member of FIG. 4A;

FIG. 4G is a cross-sectional view of the elongate member of FIG. 4G;

FIG. 4H is a cross-sectional view of a portion of the insertion end of the dental tool of FIG. 4A;

FIG. 5A is a perspective view of an insertion end of another embodiment;

FIG. 5B is a cross-sectional view of the insertion end of FIG. 5A;

FIG. 6 is a cross-sectional view of another insertion end having an o-ring;

FIGS. 7A-7E illustrate a method of removing a retention member from a cap secured in a dental appliance with a dental tool of the inventive subject matter;

FIG. 8A illustrates a front view of an expandable grabber of a dental tool according to an embodiment;

FIG. 8B is a side elevation view of the expandable grabber of FIG. 8A;

FIG. 9A is a side elevation view of an elongate member of a dental tool according to an embodiment;

FIG. 9B is a side elevation view of an elongate member of a dental tool according to an embodiment;

FIG. 10A is a front view of a handle of a dental tool according to an embodiment;

FIG. 10B is a side elevation view of the handle of FIG. 10A;

FIG. 100 is a cross-sectional view of the handle of FIGS. 10A-10B;

FIG. 11 illustrates an exemplary insertion end of an elongate member of a dental tool according to an embodiment;

FIG. 12 illustrates an exemplary tool with a mechanism to prevent expandable grabber from inadvertently being removed from an elongated member; and

FIGS. 13A-130 illustrate an exemplary tool with a push/pull mechanism, according to an embodiment.

### DETAILED DESCRIPTION

After reading this description, it will become apparent to one skilled in the art how to practice the claims in various alternative embodiments and alternative applications. However, although various embodiments will be described herein, it is understood that these embodiments are presented by way of example and illustration only, and not limitation. As such, this detailed description of various embodiments should not be construed to limit the scope or breadth of the appended claims.

In some embodiments, a dental tool comprises an elongate member, an expandable grabber, and an expander forming the first end of the elongate member.

The elongate member may include a first outer surface, a first end and a second end, wherein the first outer surface includes a first threaded portion comprising male threads. The expandable grabber may include a second outer surface, an inner surface, a third end, a fourth end, and an opening between the third and fourth ends, wherein the inner surface comprises a second threaded portion complementary to the first threaded portion of the elongate member (e.g., female threads). In some aspects, the opening of the expandable grabber may be sized and dimensioned to receive a portion of the elongate member having the first threaded portion and the expander such that the first threaded portion and the second threaded portion are configured to adjustably engage one another. An adjustment of the second threaded portion relative to the first threaded portion, for example, by rotating the expandable grabber around the elongate member, can adjust a position of the expander relative to the first end of the expandable grabber, and adjust a width of the third end of the expandable grabber.

The expander may have different widths or diameters along its length. In some contemplated aspects, the expander may have a tapered end. For example, the expander may have a uniform diameter along at least 50% of its length but include an at least partially tapered end portion. In some aspects, the expander of the elongate member may be removably coupled to the main body portion. For example, the expander may comprise a threaded end that removably engages a threaded recess of the main body portion. In some aspects, the expander portion and the main body portion may comprise a single piece. In some aspects, the expander portion and the main body portion may comprise separate pieces bonded together (e.g., via a weld, an adhesive).

The expandable grabber may comprise different widths or diameters along its length. It is also contemplated that the opening of the expandable grabber can have varying widths or diameters along its length. For example, the expandable grabber can comprise a first and second portion, wherein the first portion has a first internal width (the internal width being the width of opening) that is sized and dimensioned to receive at least a portion of the expander. The second portion may have a second internal width different from the first internal width, and be sized and dimensioned to receive a portion of the elongate member that is has a larger diameter than the expander (e.g., a portion of the elongate member comprising threads that are a part of the adjustment mechanism). Viewed from another perspective, it is contemplated that the first internal width may be between 100-120% a width of the expander portion, and that the second internal width may be between 100-120% of a width of the threaded portion. In some embodiments, the expandable grabber can comprise a third portion having a third internal width different from the first and second internal widths. The third internal width may be larger than each of the first and second internal widths, and be sized and dimensioned to receive a portion of the elongate member that is wider than the threaded portion. For example, the third internal width may be between 100-120% of a width of the main body portion above the threaded portion. An internal stop may be provided between two or more of the portions that limit an adjustment of the position of the expandable grabber relative to the elongate member.

It is contemplated that the dental tools described herein may comprise an abutment driver removably coupled to an end of the elongate member opposite the expander. In some aspects, the end of the elongate member opposite the expander may comprise a threaded portion that is configured to engage a threaded recess of the abutment driver. The abutment driver may be used to deliver an abutment to a tooth root, implant, adjacent tooth, or bar.

In some aspects, a palm-size ball handle (e.g., a ball handle having a diameter of between 1-4 inches, between 1.5-3 inches) or other handle may be provided to, for example, ease insertion of a retention member into a cap secured in a dental appliance by enabling pushing with the palm of a hand and reducing the finger strength required. Such handle can include a recess sized and dimensioned to receive at least a portion of the main body, and be positioned on the tool on an end opposite the grabber and expander. In some aspects, the end of the elongate member opposite the expander may comprise a threaded portion that is configured to engage a threaded recess of the handle. In some aspects, a recess of the handle may be configured to allow the handle to removably couple to an abutment driver.

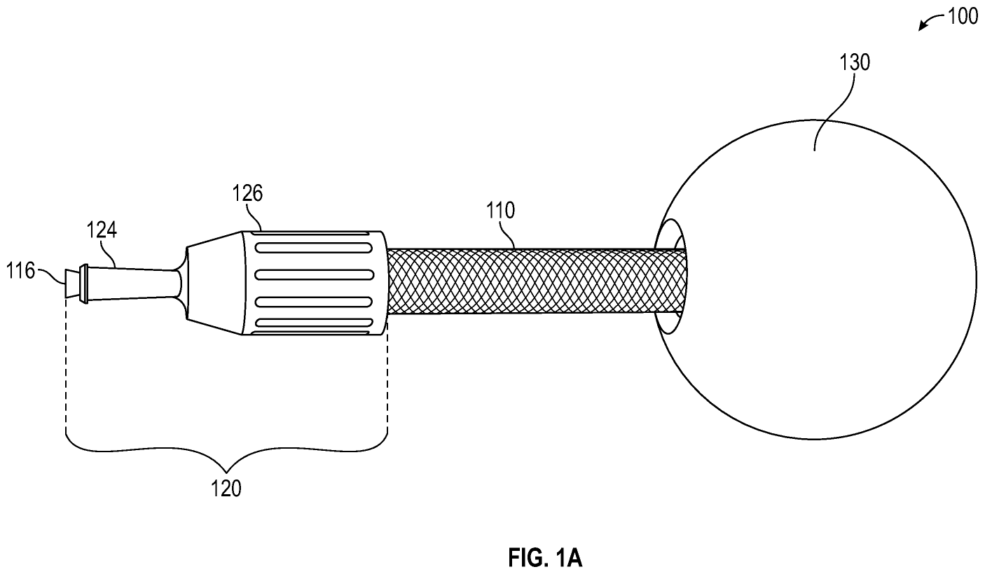

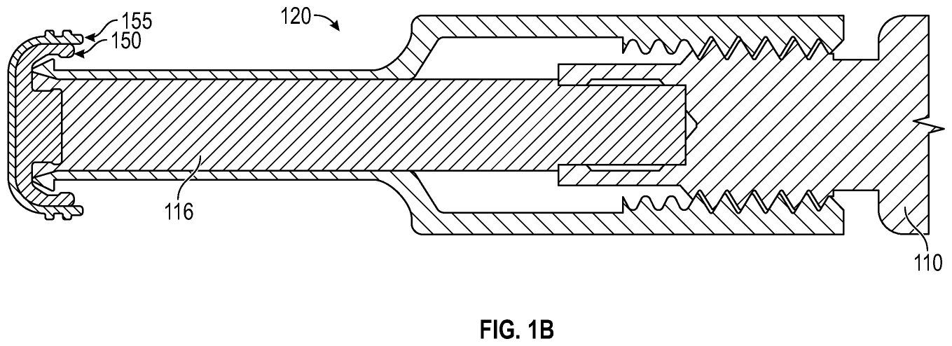

FIGS. 1A-1B illustrate an exemplary dental tool 100. Dental tool 100 comprises an expandable grabber 120 sized and dimensioned to receive a portion of elongate member 110, and a ball handle 130 positioned around an end of dental tool 100 opposite expandable grabber 120. The expandable grabber comprises an adjuster 126 and an expanding portion 124. The elongate member 110 comprises an expander 116 having a tapered end. A rotation of the expandable grabber 120 around elongate member 110 adjusts an axial position of grabber 120 relative to elongate member 110, and more specifically adjusts an axial position of expanding portion 124 relative to the tapered end, thereby adjusting a width or diameter of expanding portion 124. The grabber of dental tool of FIGS. 1A-1B can advantageously be used to seat retention members 150 of various sizes in a cap 155 secured in a dental appliance, and remove retention members 150 from a cap 155 without causing damage or breakage.

The elongate member 110 may comprise expander 116 in several different ways. As a few examples, the elongate member 110 and expander 116 can comprise a single piece of material, the elongate member 110 and expander 116 can comprise separate pieces that are bonded together, or the elongate member 110 and expander 116 can comprise separate pieces that are removably coupled to one another.

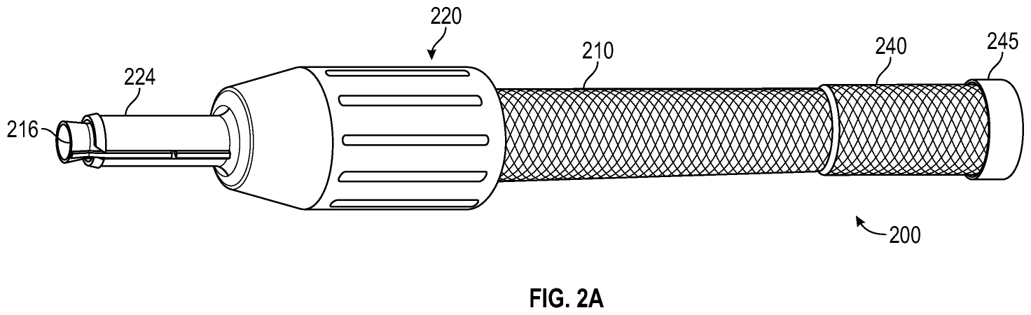

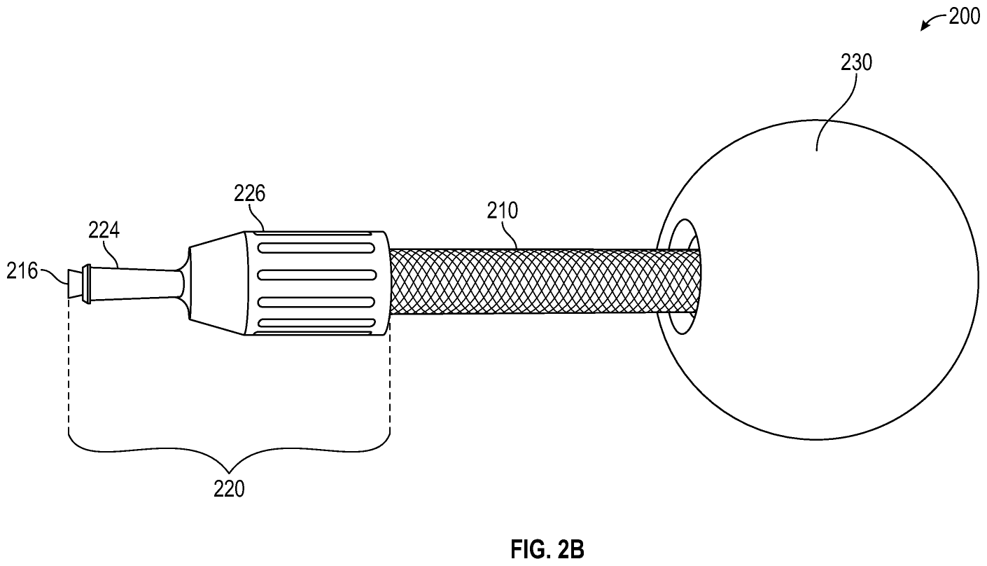

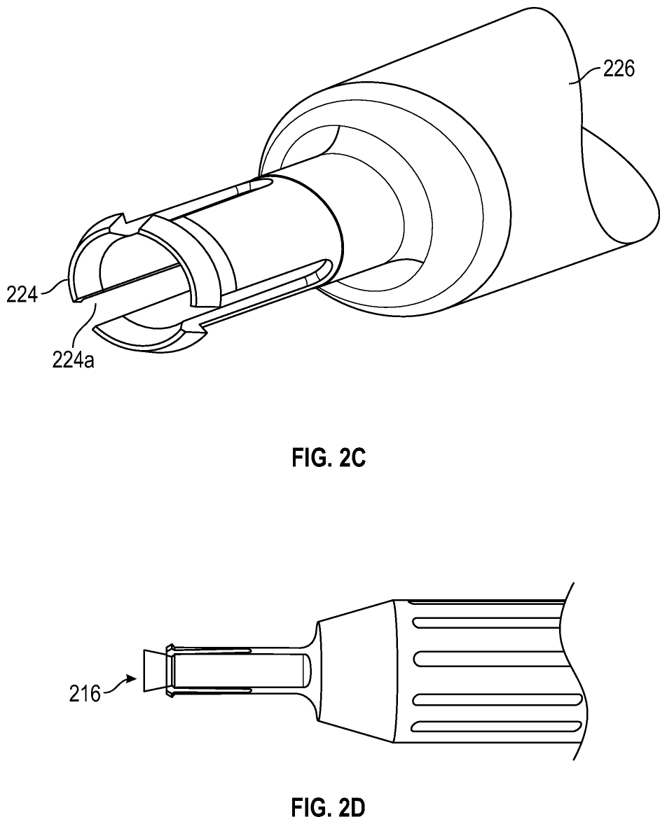

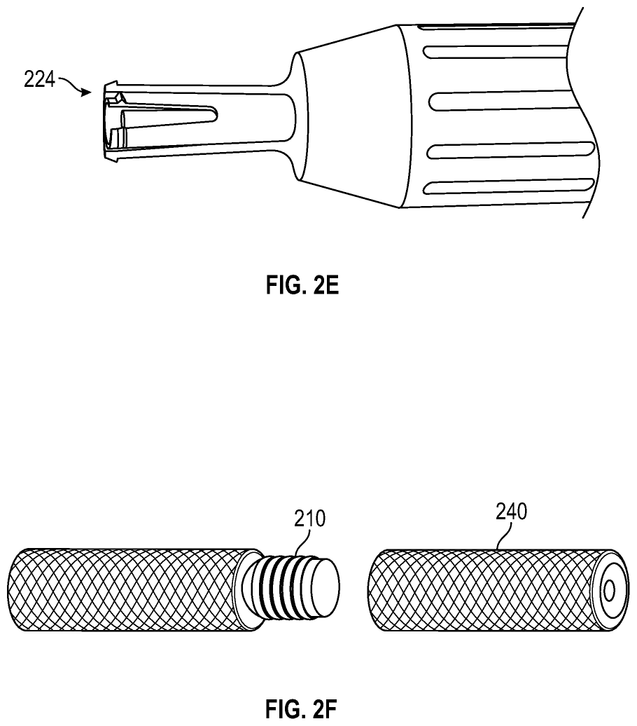

FIGS. 2A-2F illustrate another exemplary dental tool 200. Dental tool 200 comprises an expandable grabber 220 sized and dimensioned to receive a portion of elongate member 210, an abutment driver 240 removably coupled to main body 210 at an end opposite the expandable grabber, and a sleeve 245, which can advantageously be used with abutment driver 240 to allow abutment driver 240 to more securely hold an abutment. The expandable grabber 220 comprises an adjuster 226 and an expanding portion 224. The elongate member 210 comprises an expander 216 having a tapered end. A rotation of the expandable grabber 220 around elongate member 210 adjusts a position of an open end of grabber 220 relative to a tapered portion of the elongate member 210, thereby adjusting a width or diameter of expanding portion 224.

Dental tool 200 may further comprise a ball or other handle 230 comprising a recess or cavity sized and dimensioned to receive at least a portion of at least one of sleeve 245, abutment driver 240, and elongate member 210. Handle 230 advantageously allows a user to more easily apply pressure when seating a retention member into a cap, or when securing any other dental component.

As best seen in FIGS. 2C-2E, expanding portion 224 can comprise a set of cutouts 224a that can allow slight adjustments (e.g., between 0.001-0.03 inch) to be made to a width or diameter of expanding portion 224 as expandable grabber 220 is adjusted relative to expander 216. Expander 216 can have a tapered end portion that gradually becomes wider towards an end of the expander that exits the expanding portion 224. FIG. 2D illustrates expandable grabber in an upward configuration where expandable grabber is adjusted towards the abutment driver end at the upper portion of dental tool 200. FIG. 2E illustrates expandable grabber in a downward configuration where expandable grabber is adjusted away the abutment driver end, which expands expanding portion 224 (the expanding portion being at the lower portion of dental tool 200).

Although expanding portion 224 comprises cutouts in the embodiment described herein, it should be appreciated that expanding portion 224 can comprise other mechanisms that allow for expansion wile being sufficiently rigid for use in removing and seating a retention member.

FIG. 2F illustrates a portion of elongate member 210 that removably couples with abutment driver 240. Abutment driver 240 comprises a threaded recess (not shown) that is sized and dimensioned to receive at least a portion of a threaded portion of elongate member. The abutment driver may be used optionally with an abutment driver sleeve to carry an abutment securely and place it onto an implant. The abutment driver may comprise a first end having the threaded recess, and a second end that has an internal recess sized and dimensioned to receive an outer portion of an abutment, which can then be carried over to the implant system where the abutment will be fastened. Where provided, the sleeve can be placed over the second end, and assist in keeping the abutment in place on the dental tool while being carried over to the implant system.

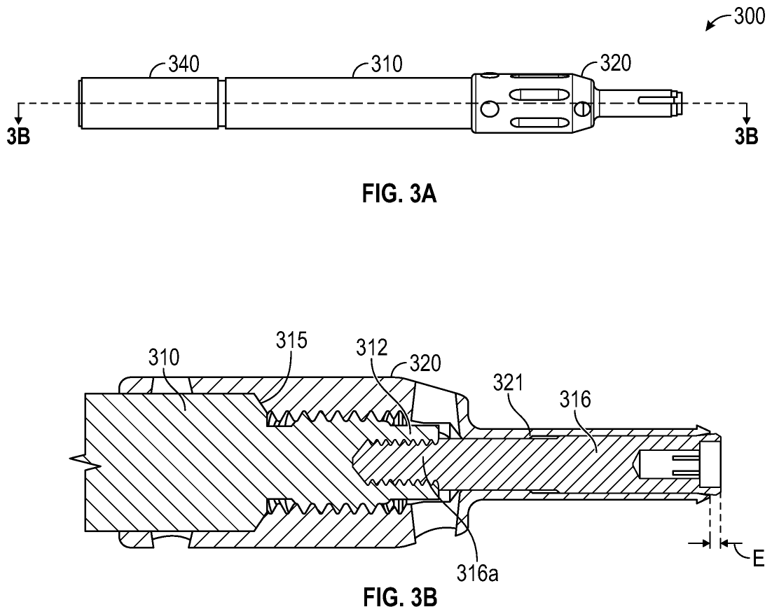

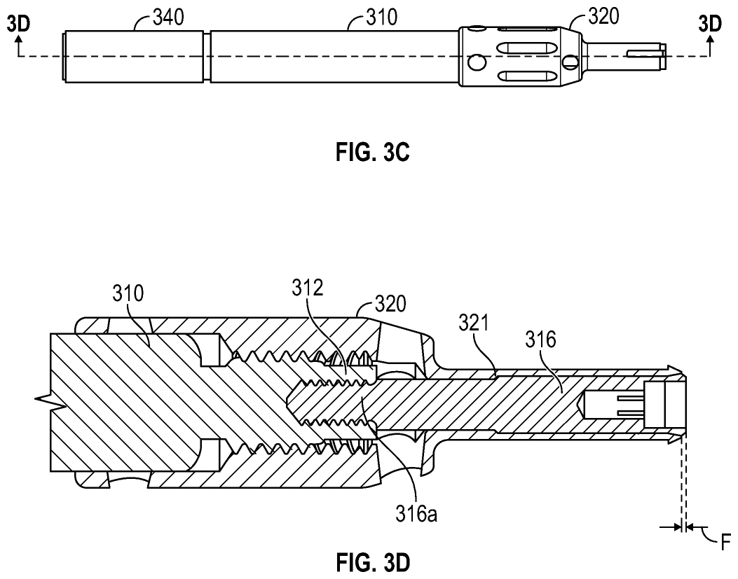

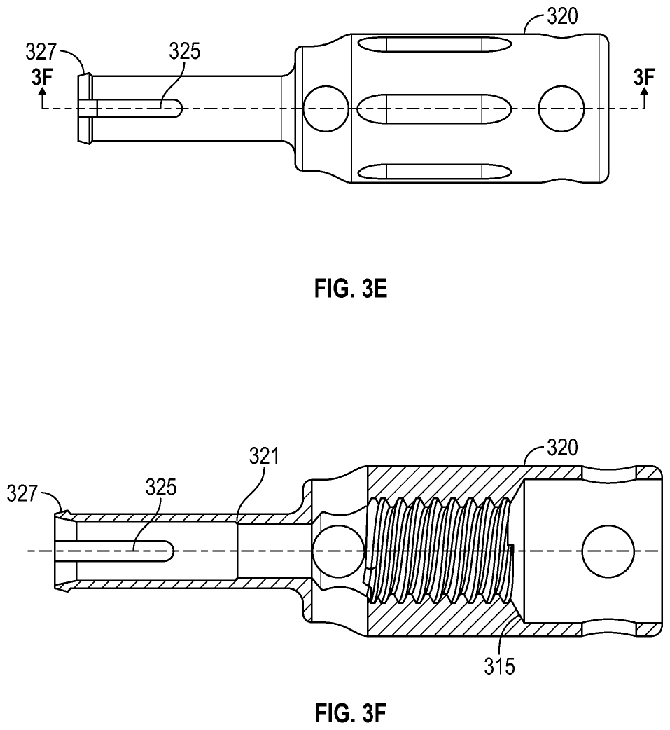

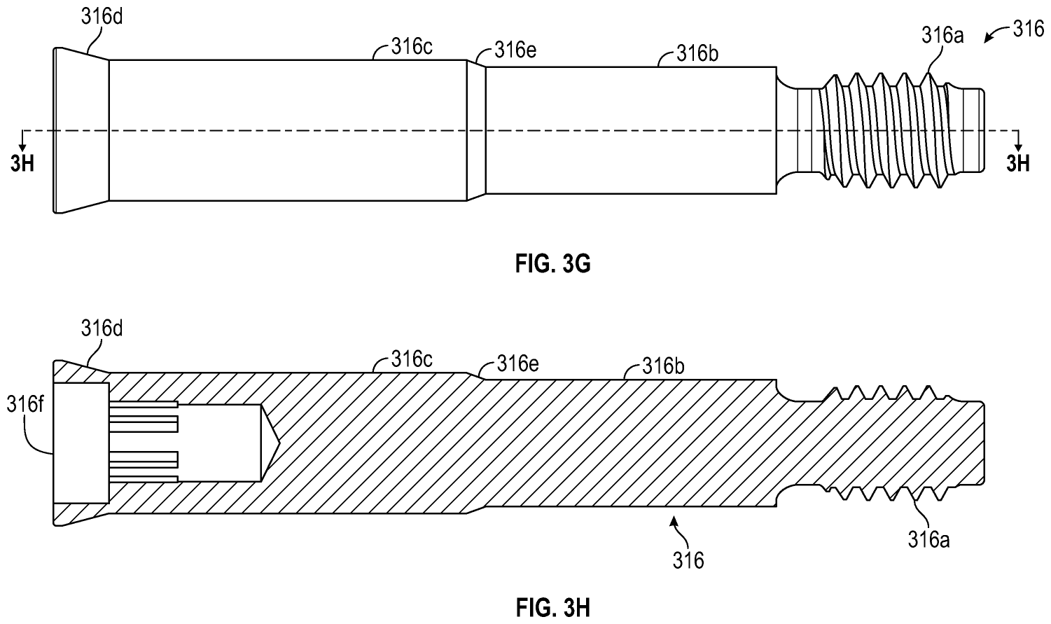

FIGS. 3A-3H illustrate dental tool 300, which includes an elongate member having an expander, wherein the expander is removably coupled to a main body portion via a threaded fastener. A removable expander can advantageously enhance the cleanability of the dental tool 300 (e.g., from patient saliva).

Dental tool 300 comprises an expandable grabber 320 sized and dimensioned to receive a portion of elongate member 310, an abutment driver 340 removably coupled to main body 310 at an end opposite the expandable grabber, and may optionally include a sleeve (not shown), which can advantageously be used with abutment driver 340 to allow abutment driver 340 to more securely hold an abutment. The expandable grabber 320 comprises an adjuster and an expanding portion. An adjustment mechanism is provided comprising a set of threads on an inner surface of grabber 320 and a set of complementary threads on an outer surface of elongate member 310. The elongate member 310 comprises an expander 316 having a tapered first end and a second end 316a sized and dimensioned to be received by a recess 312 of elongate member 310. A rotation of the expandable grabber 320 around elongate member 310 adjusts a position of an open end of grabber 320 relative to a tapered first end of the expander 316 of elongate member 310, thereby adjusting a width or diameter of the expanding portion of expandable grabber 320.

As best seen in FIGS. 3B, 3D, and 3F-3H, expander 316 has a tapered end portion 316d that gradually becomes wider towards an end of the expander that exits the expanding portion of expandable grabber 320. Expander 316 further has a recess 316f, which is sized and dimensioned to receive an inner nub of some contemplated retention members. Such a recess 316f can allow the retention member to be picked up by an expander 316 of a tool. Below recess 316f is a broached hex for driving/securing expander 316 into a mating component, for example, another portion of elongate member 310. FIG. 3B illustrates expandable grabber in an upward configuration where expandable grabber is adjusted towards the abutment driver end, resulting in a length E of expander 316 being positioned outside of expandable grabber 320. FIG. 3D illustrates expandable grabber in a downward configuration where expandable grabber is adjusted away the abutment driver end, resulting in a length F (smaller than length E) of expander 316 being positioned outside of expandable grabber 320, which expands expanding portion 224. It should be appreciated that dental tool 300 can be configured such that the expander is positioned entirely within the expandable grabber when the expandable grabber is in a downward configuration. In some aspects, there may be an internal gap between the end of expander and the opening of the expanding portion when the expandable grabber is in a downward configuration.

As best seen in FIGS. 3E-3F, expanding portion of expandable grabber 320 comprises a set of cutouts 325 that can allow slight adjustments to be made to a width or diameter of the expanding portion as expandable grabber 320 is adjusted relative to expander 316. Expanding portion of expandable grabber 320 further comprises an annular tapered flange 327 that becomes progressive smaller in a downward direction. Flange 327 can advantageously allow for a snap engagement of the expanding portion with a retention member (for example, as shown in FIG. 1B).

The expander may comprise one or more additional tapered regions positioned between portions of different widths or diameters as best seen in FIGS. 3G-3H. Expander 316 comprises a first upper end portion optionally comprising a set of threads 316, for engaging with an optional threaded recess of the main body portion of expandable grabber 320, and a second lower end portion 316d that is tapered. It should be appreciated that in some embodiments, the expander and the recess of the main body portion that receives the expander may not include complementary threading, and the two components may be bonded together.

Expander 316 further comprises portion 316b having a first width or diameter, portion 316c having a second width or diameter greater than the first diameter, and a tapered portion 316e between portion 316b and 316c. In some embodiments, an entire length of expander 316 may have a width or diameter that is less than 0.2 inches, or less than 0.15 inches. The opening extending between the inner surface of the expanding portion of expandable portion 320 includes complementary tapered portions between portions of different internal widths or diameters, as best seen in FIGS. 3B, 3D, and 3F. Such an expander and expanding portion can advantageously prevent a downward movement of the expanding portion relative to the expander beyond a predetermined point (the point where 316e and 321 meet).

While the Figures show an expander and expanding portion with tapered regions between segments of different widths or diameters, it should be appreciated that the dental tool can comprise expanders and expanding portions with segments of different widths or diameters without tapered regions therebetween to similarly prevent a movement of the expanding portion relative to the expander beyond a predetermined point.

A second stop 315 as best seen in FIGS. 3B and 3D may be provided to prevent an upward movement of expanding portion relative to the expander beyond a predetermined point. The second stop may be formed between a set of threads that engages a set of threads of expandable grabber 320, and a wider portion of the main body of the elongate member 310. The first and second stops can prevent a movement of the expandable grabber relative to a length of elongate member such that the expandable grabber may be adjusted no more than 0.1 inch, no more than 0.08 inches, no more than 0.06 inches, no more than 0.05 inches, or no more than 0.4 inches downward or upward relative to the elongate member.

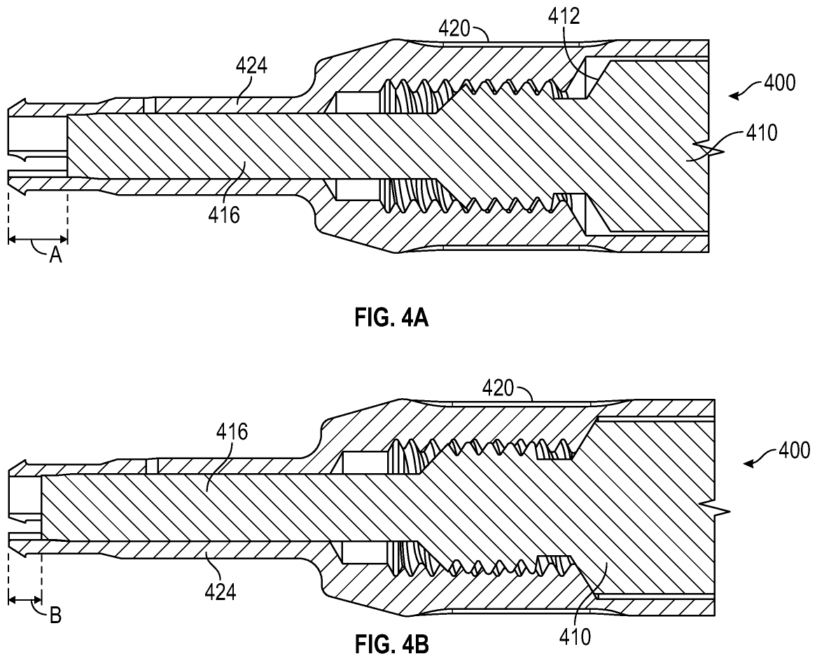

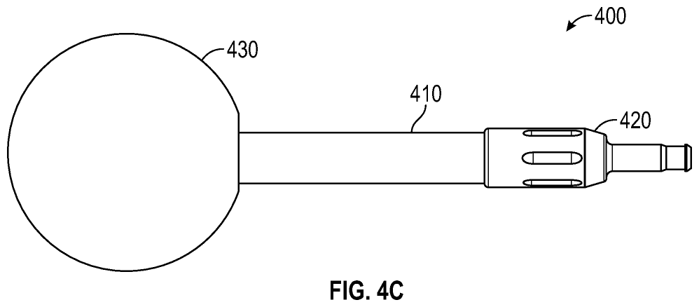

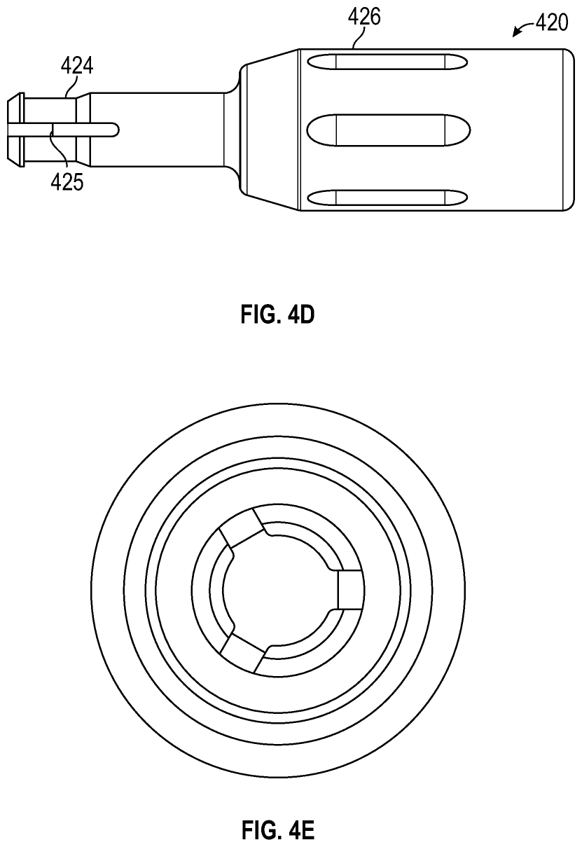

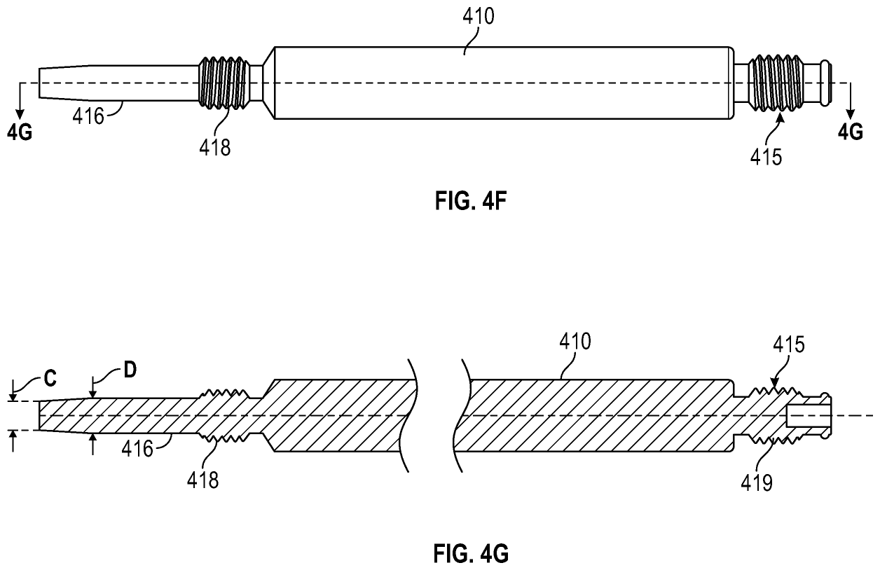

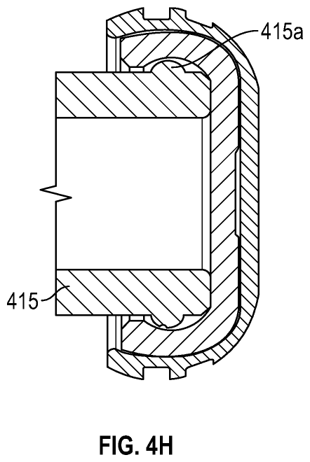

FIGS. 4A-4H illustrate another embodiment of a dental tool 400 having an expander with a reverse taper.

Dental tool 400 comprises an expandable grabber 420 sized and dimensioned to receive a portion of elongate member 410, and a ball or other handle 430 comprising a threaded recess sized and dimensioned to receive at least a portion of the elongate member 410, or optionally another tool component coupled with the elongate member. The expandable grabber 420 comprises an adjuster 426 and an expanding portion 424. The elongate member 410 comprises an expander 416 having a tapered end portion that gradually becomes narrower towards an end of the expander that exits the expanding portion 224 (as shown in FIGS. 4F and 4G with C being smaller than D). The main body of expandable grabber 420 comprises an outer surface with a threaded portion 418 that is complementary to a threaded portion 423 on an inner surface of expandable grabber. A rotation of the expandable grabber 420 around elongate member 410 adjusts a position of an open end of grabber 420 relative to a tapered portion of the elongate member 410, thereby adjusting a width or diameter of expanding portion 424. As best seen in FIGS. 4A-4B, a distance between an end of expander 416 and an opening of expanding portion 424 can be adjusted between distances A and B, wherein the difference between A and B may be between 0.01-0.2 inches, between 0.01-0.1 inches, between 0.02-0.06 inches, between 0.03-0.05 inches, or any other suitable length. A stop 412 is provided between the threaded portion 418 and a larger diameter portion of the main body portion to prevent an adjustment of the expandable grabber 420 relative to elongate member 410 beyond a predetermined position.

Expanding portion 424 of expandable grabber 420 may comprise a set of cutouts 425 that can allow slight adjustments to be made to a width or diameter of the expanding portion as expandable grabber 420 is adjusted relative to expander 416.

As best seen in FIGS. 4F-4H, dental tool 400 comprises a push style insertion end 415. Insertion end 415 has an outer surface comprising an annular protrusion 415a, which can advantageously allow for a snap engagement of the insertion end with a retention member or other component of a dental attachment assembly.

Insertion end 415 can further comprise a set of threads 419 complementary to a set of threads of at least one of an abutment driver (e.g., abutment driver 240), a handle, and another dental tool component.

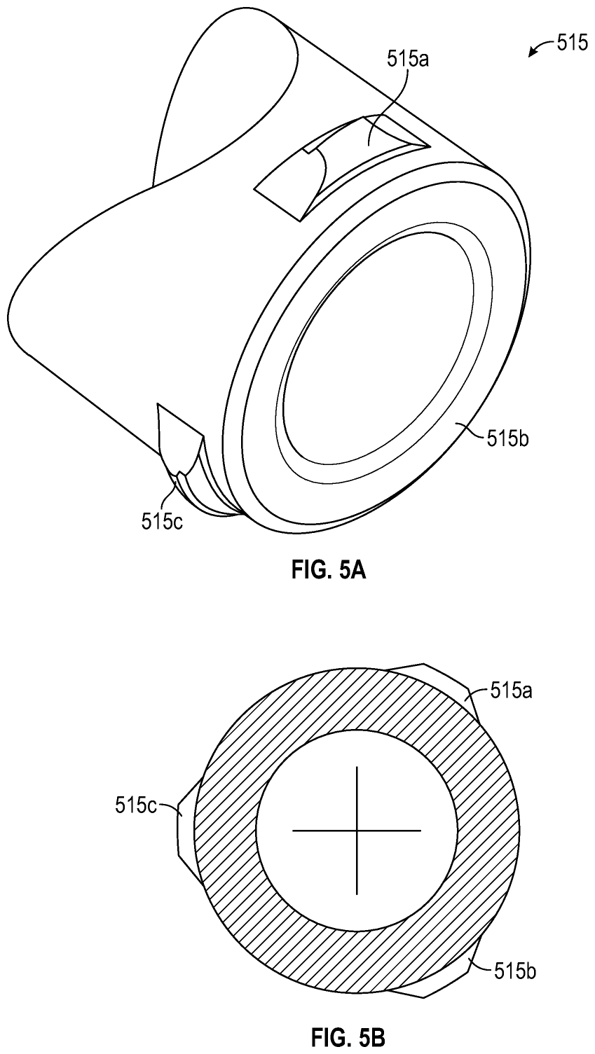

FIGS. 5A-5B illustrate another insertion end of a driver tool comprising a set of radial protrusions. Additionally or alternatively to an annular protrusion 415 that is ring shaped, as shown in FIGS. 4A-4H, an insertion end 515 of a driver tool may comprise a set of annular protrusions 515a, 515b, 515c, which may be tapered and similarly configured to allow for a snap engagement of the insertion end with a retention member or other component of a dental attachment assembly.

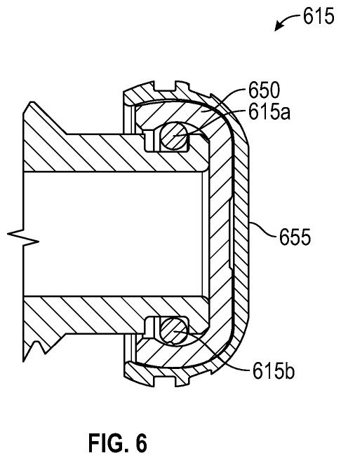

FIG. 6 is a cross-sectional view of a portion of yet another insertion end 615 having a rubber or other o-ring 615b seated in an annular recess 615a, and the o-ring 615b can act similarly to an annular protrusion to allow for a snap engagement of the insertion end 615 with a retention member 650 positioned within cap 655 that is secured to a dental appliance.

It should be appreciated that the insertion ends described in FIGS. 4A-6 can be provided in any of the dental tools contemplated herein, including, dental tool 100, dental tool 200, and dental tool 300. It should also be appreciated that an outer threaded portion of the insertion end can be complementary to a threaded portion of a recessed portion of an abutment driver, a handle, or any other suitable component of a dental tool.

The expanders described herein may be made of any suitable material(s) (e.g., a metal, a plastic), and can be of any suitable length and width or diameter. In some aspects, the expander may have a length of between 0.25-1.5 inches, between 0.5-0.75 inches, between 0.65-0.725 inches, or any other suitable length. The tapered end of the expander can comprise any suitable length, including for example, 0.01-0.5 inches, between 0.03-0.05 inches, 0.04-0.05 inches, or any other suitable length. In some aspects, the expander may have a diameter or width that is no greater than 0.3 inches, no greater than 0.2 inches, or no greater than 0.15 inch. The tapered end of the expander can taper such that a difference between the width or diameter of a first end of the tapered portion and the width or diameter of a second end of the tapered portion is of any suitable amount, including for example, 0.001-0.1 inches, between 0.001-0.03 inches, between 0.01-0.025 inches, or any other suitable amount. For example, a first end of the tapered end can have a diameter of about 0.12 inches, and a second end of the tapered end can have a diameter of about 0.10 inches.

The expandable grabbers described herein may be made of any suitable material(s) (e.g., a metal, a plastic), and can be of any suitable length and width or diameter. In some aspects, an expandable grabber may have a length of between 0.75-2 inches, between 0.8-1.5 inches, between 1-1.2 inches, or any other suitable length. Each of the adjuster and the expanding portion can comprise between 30-70% of the length of the expandable grabber. An outer or inner diameter or width of the adjuster may be larger than a diameter or width of the expandable portion by between 110-250%, between 150-250%, between 200-300%, or any other suitable amount. In some aspects, the expandable grabber may have an outer width or diameter that is no greater than 0.8 inches, and an inner width or diameter that is no greater than 0.65 inches.

The elongate members described herein may be made of any suitable material(s) (e.g., a metal, a plastic), and can be of any suitable length and width or diameter. In some aspects, an elongate member may have a length of between 2-5 inches, between 2-4 inches, between 2.5-3 inches, or any other suitable length. The main body portion, which can comprise a first set of threads and a second set of threads, may comprise at least 50%, at least 60%, at least 70%, or any other suitable percentage of the length of the elongate member. A central portion of the main body portion between the first and second threaded portions may comprise a uniform diameter or width that is between 0.1-1 inch, between 0.2-0.8 inch, between 0.3-0.6 inch, or any other suitable diameter or width.

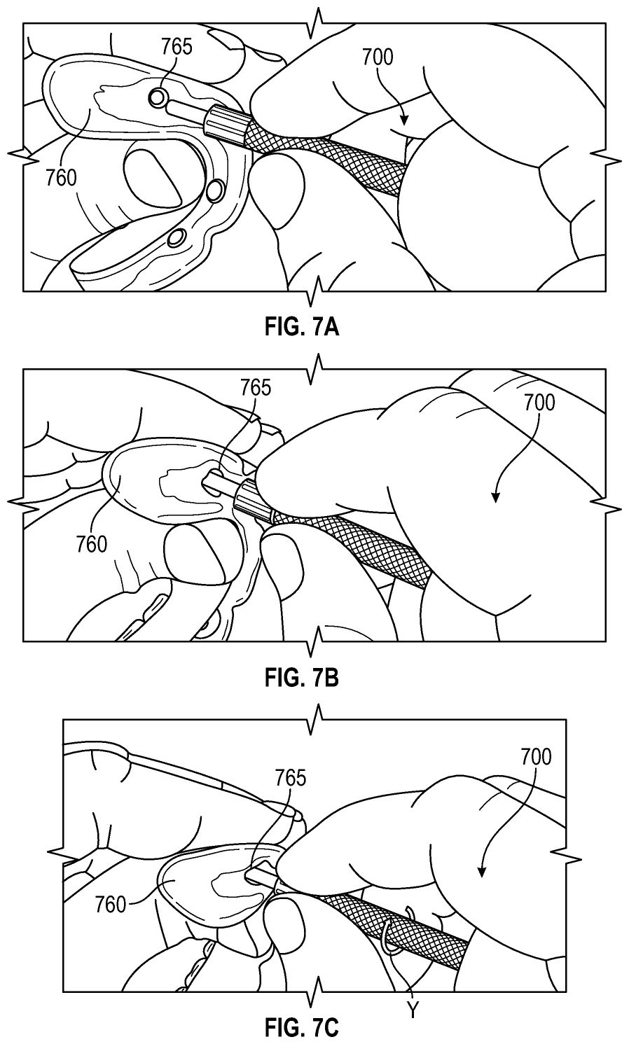

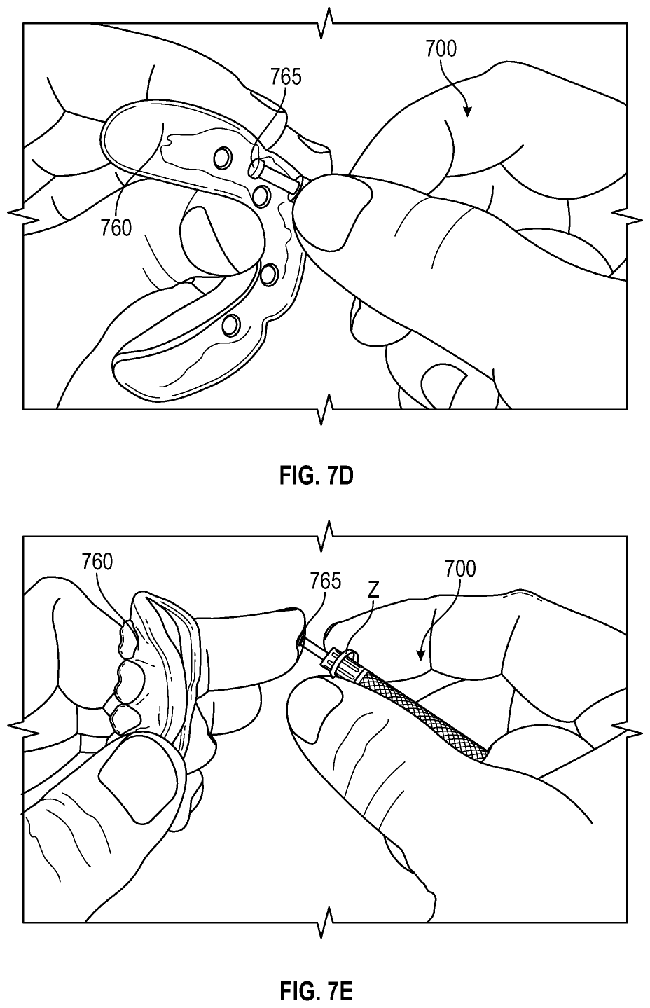

FIGS. 7A-7E illustrate a method of removing a retention member from a cap secured in a dental appliance with a dental tool of the inventive subject matter.

As shown in FIGS. 7A-7B, a user may use dental tool 700 and insert the expandable grabber end within a retention member 765, which is seated in a dental cap secured in dental appliance 760 (here, a denture). As shown in FIG. 7c, the user may rotate expandable grabber relative to expanding member in direction Y to cause an end width or diameter of the expandable grabber to expand and secure retention member 765. The expanding of expandable member 765 allows a user to effectively remove retention member 765 from dental appliance 760, as shown in FIG. 7D. The user may then rotate expandable grabber 700 in direction Z to release the retention member from the expandable grabber, as shown in FIG. 7E.

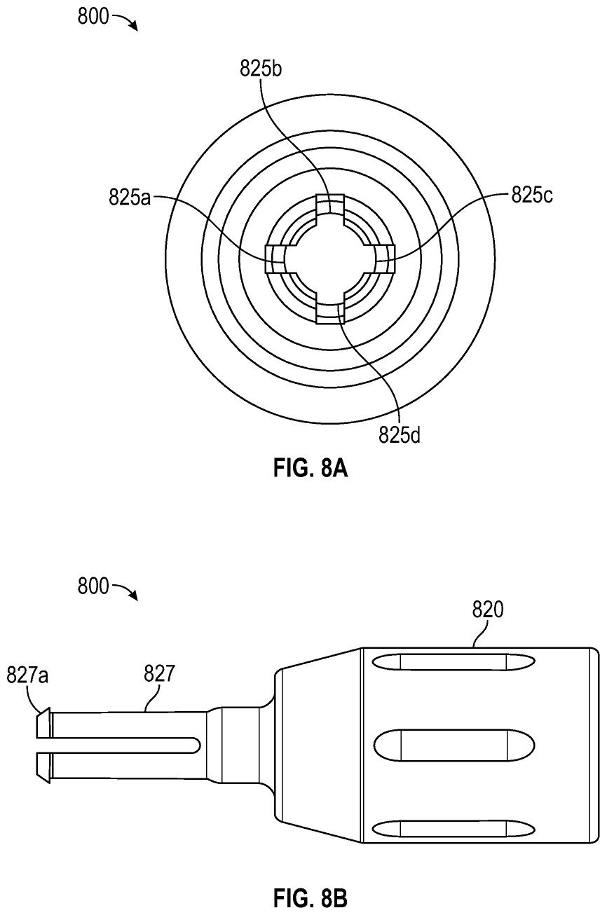

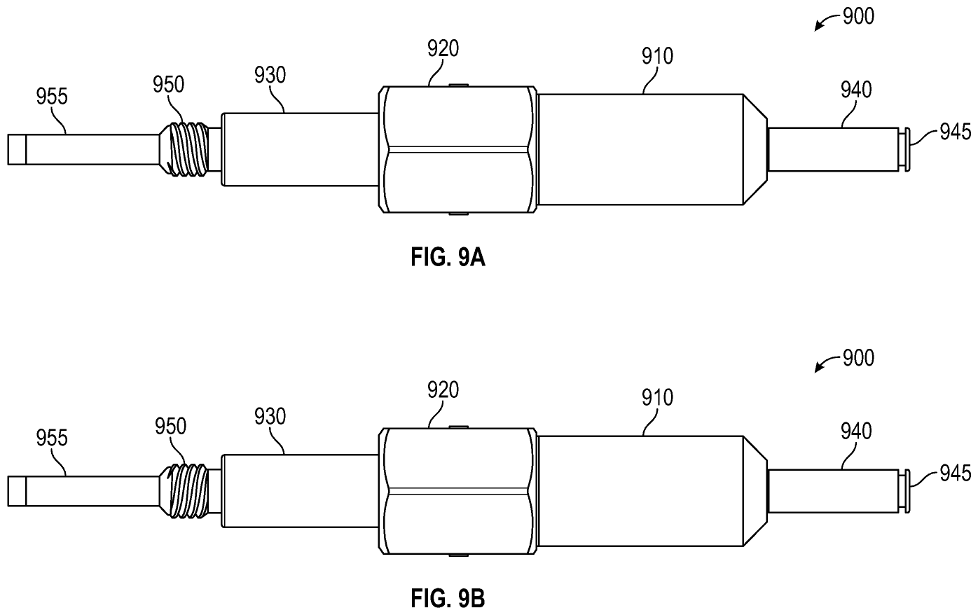

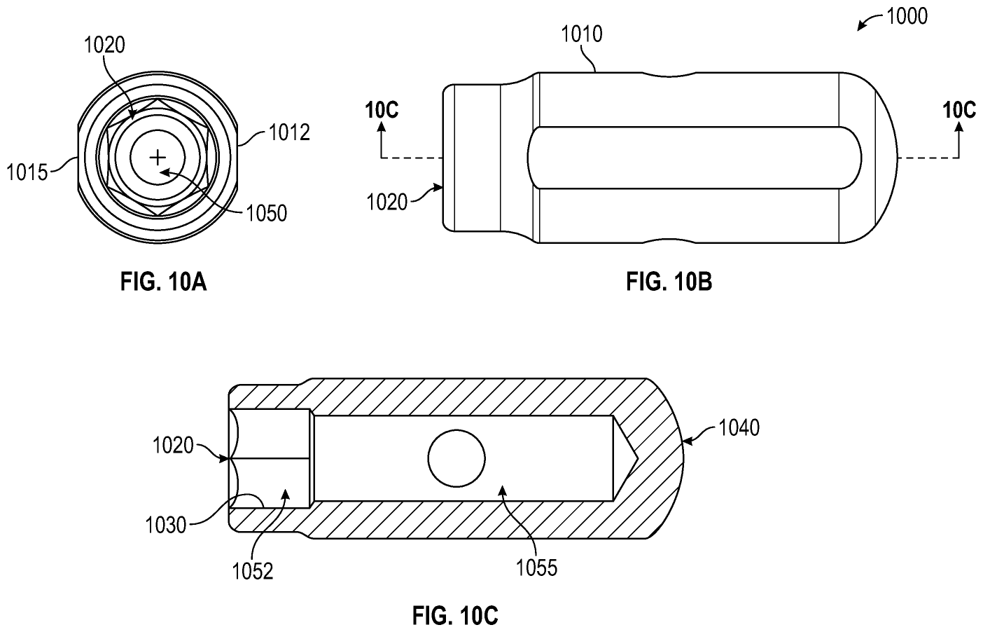

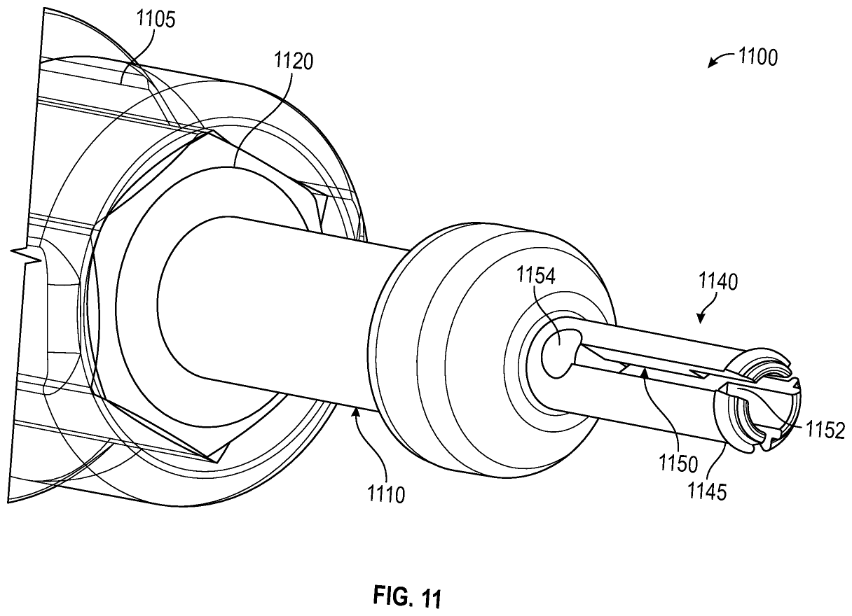

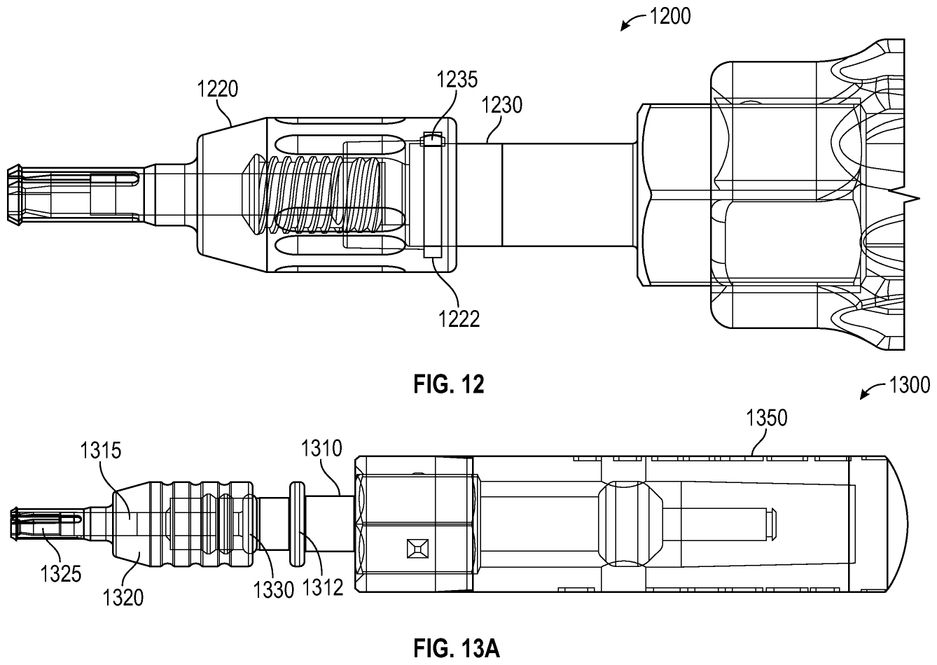

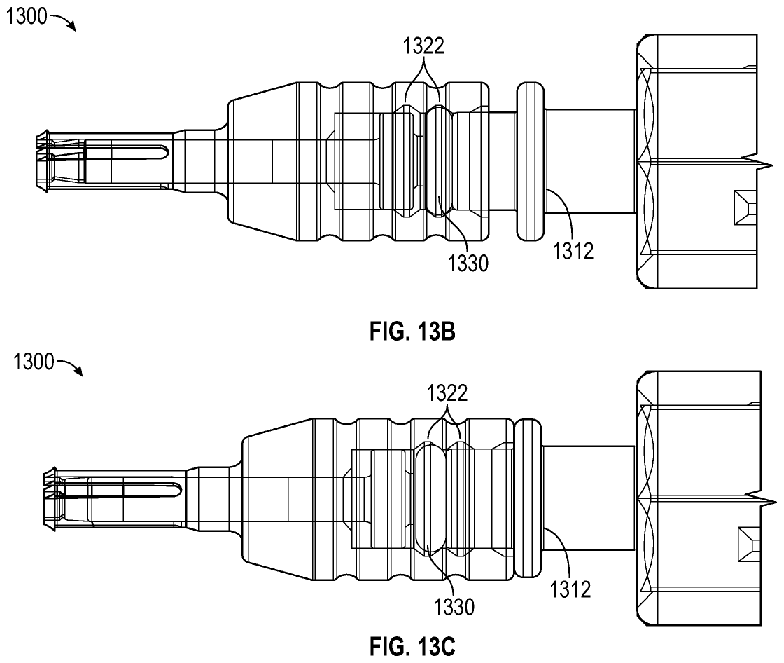

FIGS. 8A-8B illustrate another exemplary expandable grabber 800 of an exemplary dental tool. Expandable grabber 800 can be sized and dimensioned to receive a portion of an elongate member (e.g., elongate member 900 of FIGS. 9A-9B). The expandable grabber can comprise an adjuster 820 and an expanding portion 827. A handle (e.g., handle 1000 of FIGS. 10A-10C) may also be provided, which can comprise a cavity sized and dimensioned to receive a portion of the elongate member.

It should be appreciated that expandable grabber 800 can be used with any suitable elongate member, including elongate member 900 or any of the elongate members described herein (e.g., elongate member 110, 210, 310, 410). It should also be appreciated that expandable grabber 800 can be used with any suitable handle, including handle 1000 or any of the handles described herein (e.g., 130, 230, 430). Elongate member 900 can be used with any suitable expandable grabber, including expandable grabber 800 or any of the expandable grabbers described herein (e.g., expandable grabber 120, 220, 320, 420). Elongate member 900 can be used with any suitable handle, including handle 1000 or any of the handles described herein (e.g., 130, 230, 430). Handle 1000 may be used with any suitable elongate member, including elongate member 900 or any of the elongate members described herein (e.g., elongate member 110, 210, 310, 410). Handle 1000 may be used with any suitable expandable grabber, including expandable grabber 800 or any of the expandable grabbers described herein (e.g., expandable grabber 120, 220, 320, 420).

Elongate member 900 can comprise a handle engaging portion 920, a first side portion 930 extending from a first end of handle engaging portion 920 and comprising an expander portion 955 and threaded portion 950, and a second side portion 910 extending from a second end of handle engaging portion 920. Second side portion 910 can comprise a seating end portion 940, which can comprise one or more projections (e.g., o-ring) 945. Handle engaging portion 920 can be sized and dimensioned to be removably secured within a cavity of a handle (e.g., handle 1000), and can comprise a polygonal (e.g., hexagonal) cross-sectional shape to prevent a rotation of elongate member 900 relative to handle 1000.

The expander portion (or expander) may have different widths or diameters along its length. In some contemplated aspects, the expander may have a uniform diameter along about 80% of its length but include an at least partially tapered end portion. In some contemplated aspects, the first side portion may have a first portion adjacent handle engaging portion and having a first diameter, a second portion (e.g., expander) having a second diameter different from the first diameter, a threaded portion 950 between the first and second portions, and the second portion can comprise a tapered or reverse tapered end portion. The different diameters of the first side portion may correspond to different internal diameters of expandable grabber (e.g., 800), and a stop may be formed between the different diameter portions as described herein. In some aspects, the first side portion of the elongate member may be removably coupled to another portion of the elongate member (e.g., the handle engaging portion 920). For example, the first side portion may comprise a threaded end (not shown) separate from threaded portion 950 that removably engages a threaded recess of the handle engaging portion (not shown). In some aspects, the first side portion, the second side portion and the handle engaging portion may comprise a single piece. In some aspects, the first side portion, the second side portion and the main body portion may comprise separate pieces bonded together (e.g., via a weld, an adhesive).

It should be appreciated that a handle engaging portion as described herein in connection with elongate member 900 can be provided in other elongate members, including elongate members 110, 210, 310, or 410, for example along a mid-portion of the main body portion of the elongate members.

The expandable grabber may include a central opening that extends through the length of the expandable grabber, and that is sized and dimensioned to receive a portion of the elongate member, for example, at least a portion of the first side portion 930 including expander portion 955. It is contemplated that the expandable grabber may comprise different widths or diameters along its length. It is also contemplated that the opening of the expandable grabber can have varying widths or diameters along its length such that different portions of the opening are sized and dimensioned to secure different components of the elongate member. For example, the expandable grabber can comprise a first and second portion, wherein the first portion has a first internal width (the internal width being the width of opening) that is sized and dimensioned to receive at least a portion of the expander. The second portion may have a second internal width different from the first internal width, and be sized and dimensioned to receive a portion of the elongate member that is has a larger diameter than the expander portion (e.g., a portion of the first side portion comprising threaded portion, which can be a part of the adjustment mechanism). Viewed from another perspective, it is contemplated that the first internal width may be between 100-120% a width of the expander 955, and that the second internal width may be between 100-130% or between 100-120% of a width of the threaded portion. In some embodiments, the expandable grabber can comprise a third portion having a third internal width different from the first and second internal widths. The third internal width may be larger than each of the first and second internal widths, and be sized and dimensioned to receive a portion of the first side portion that is wider than the threaded portion. For example, the third internal width may be 100-120% of a width of the first side portion above the threaded portion. An internal stop may be provided between two or more of the portions that limit an adjustment of the position of the expandable grabber relative to the elongate member.

The adjustment mechanism may be coupled to the elongate member and the expandable grabber (or comprise complementary threads on outer surface of elongate member and inner surface of expandable grabber), and be configured to adjust a position of expandable grabber relative to the elongate member. For example, the adjustment mechanism may comprise complementary threaded portions, wherein an outer surface of the elongate member includes a first threaded portion 950, wherein an inner surface of the expandable grabber 800 includes a second threaded portion, and wherein a rotation of the expandable grabber 800 relative to the elongate member 900 adjusts an axial position of the expandable grabber 800 relative to elongate member 900 (e.g., an axial position of expanding portion 827 relative to end portion 955, which may be tapered), thereby adjusting the diameter or width of the first end of the opening (e.g., or the expanding portion 827). Expanding portion of expandable grabber 800 can also comprise an annular tapered flange 827a that, for example, becomes progressive smaller in a downward direction. Flange 827a can advantageously allow for a snap engagement of the expanding portion with a retention member (for example, as shown in FIG. 1B).

However, any suitable adjustment mechanism for moving a position of the expandable grabber relative to the elongate member is contemplated herein.

As shown in FIGS. 8A-8B, expanding portion 827 comprises four cutouts 825a-825d. However, it should be appreciated that any suitable number of cutouts may be provided (e.g., 1, 2, 3, 4, 5). As shown in FIGS. 9A-9B, threaded portion 950 can comprise right-handed threading (FIG. 9B) or left-handed threading (FIG. 9A).

In some embodiments, the expandable grabber 800 and expander portion 955 of elongate member 900 can advantageously be used to pick up, move, and seat retention members (e.g., 150) of various sizes in a cap (e.g., 155) secured in a dental appliance, and further to remove retention members from a cap without causing damage or breakage. In some embodiments, expandable grabber 800 and expander portion 955 can be used to remove retention members from caps without causing damage or breakage, and seating end portion 940 can be used to pick up, move, and seat retention members in caps. For example, seating end portion 940 can comprise a push style insertion end including one or more projections 945, which can advantageously allow for a snap engagement of the insertion end with a retention member or other component of a dental attachment assembly. The one or more projections 945 can comprise, among other things, an annular protrusion (e.g., as shown and described as 415a), a set of annular protrusions (e.g., as shown and described as 515a, b, c), an o-ring, for example o-ring 615b seated in an annular recess 615a, and the o-ring 615b), or a slotted ring 1145 as shown in FIG. 11. Contemplated protrusions can be made of any suitable material(s), including for example, a plastic, a metal, or a rubber, a nitrile, a neoprene, fluorocarbon, or silicone.

FIGS. 10A-100 illustrate an exemplary handle 1000 comprising an outer surface 1010, a first open end 1020, a second closed end 1040, a cavity 1050, and an inner surface 1030. The first open end 1020 and cavity 1050 can be sized and dimensioned to receive at least a portion of handle engaging portion 920 and alternatingly the first side portion 930 comprising an expander end portion 955 and threaded portion 950, and the second side portion 910 comprising a seating end portion 940, which can comprise one or more projections 945. To use the seating end portion, the first side portion 930 and at least a portion of handle engaging portion 920 can be secured through open end 1020 and within cavity 1050. To then use the expander portion 955, the first side portion and the at least the portion of handle engaging portion 920 can be removed from cavity 1050 via open end 1020 of handle 1000, and the second side portion 910 and at least a portion of handle engaging portion 920 can be secured through open end 1020 and within cavity 1050.

As best seen in FIG. 10A, open end 1020 can comprise a polygonal shape (when viewed from open end 1020 as shown in FIG. 10A), which can prevent a rotation of elongate member 900 within handle 1000. Viewed from another perspective, inner surface 1030 at open end 1030 can form a hexagonal shape. In some other embodiments, it should be appreciated that open end can comprise any suitable regular and irregular polygonal shapes. It should also be appreciated that open end 1020 can comprise a circular or other suitable shape

In some aspects, a first portion 1052 of cavity 1050 (or inner surface 1030), which can be positioned at or adjacent open end 1030, at or adjacent closed end 1040, or anywhere in between, can have a hexagonal (or other polygonal) shape corresponding to a hexagonal (or other polygonal) shape of handle engaging portion 920 of elongate member 900. The first portion 1052 can be sized and dimensioned to match, to be slightly larger than, or to be slightly smaller than handle engaging portion 920, preferably to provide a secure fit. For example, a length of each of the sides of an inner surface 1030 forming first portion 1052 of cavity 1050 (e.g., each of the six sides of 1020) can be equal or substantially equal (e.g., within 10%, within 5% of) to a length of each side of an outer surface of a hexagonal handle engaging portion (e.g., 920). In some aspects, a second portion 1055 of cavity 1050 (or inner surface 1030), which can be positioned at or adjacent open end 1030, at or adjacent closed end 1040, or anywhere in between, can have a circular or other suitable shape different from the first portion 1052. In some aspects, cavity 1050 (or inner surface 1030) can comprise 2, 3, 4, 5 or even more portions along a length of the handle (from open end to closed end) with varying shapes or dimensions. For example, a cavity 1050 (or inner surface 1030) can comprise, from open end to closed end, a first portion that is circular, a third portion that is circular, and a second, polygonal portion between the first and third portions. As another example, a cavity 1050 (or inner surface 1030) can comprise, from open end to closed end, a first portion that is polygonal, a second portion that is circular, and a third portion that is circular but larger or smaller than the second portion.

As best seen in FIG. 10A, handle 1000 can comprise one, two, three, four, or even more flat outer surface portions (e.g., 1012, 1015) to prevent a rolling of handle 1000 or assembled tool when placed on a table or other surface.

While FIGS. 10A-10B illustrate a handle 1000 having an open end and a closed end, it should be appreciated that contemplated handles can comprise, among other things, a first open end and a second open end, with an opening extending through the first and second ends (e.g., tube-shaped).

FIG. 11 illustrates an exemplary second side portion 1110 of a dental tool 1100, which extends from a handle engaging portion 1120 of an elongate member. Handle engaging portion 1120 and a first side portion of the elongate member (not shown) can be positioned at least partially in a cavity of handle 1105. Seating end portion 1140 comprises a slotted ring 1145, which can be positioned on a slotted or unslotted seating end portion 1140. In some aspects, as shown in FIG. 11, the seating end portion 1140 can be slotted and comprise one or more slots (e.g., 1, 2, 3, 4, 5) that each extends from a tip of seating end portion 1140 through ring 1145 (e.g., to form a slotted ring), and in a direction towards handle engaging portion 1120. The slot(s) can be of any suitable length, for example, between 0.1-30 mm, between 0.1-20 mm, between 0.1-10 mm, between 1-10 mm, or any other suitable length. In some aspects, an end portion 1154 of a slot (e.g., an end portion of the slot 1150 closest to handle engaging portion 1120) can comprise a rounded shape and have a width greater than the width of the slot at an opposite end portion 1152 (e.g., end portion that is adjacent (e.g., within about 0.1-10 mm or 0.1-5 mm or 0.1-3 mm of) ring 1145). The projections of slotted ring 1145 can be positioned in a recess of a retention member, to hold the retention member in place on the tool until the retention member can be placed in a cap secured in a dental appliance. The slot(s) can advantageously allow seating end portion to be used to seat retention members without expanding or damaging the retention member (e.g., thin or worn retention members). For example, in the embodiment shown in FIG. 11, the seating end portion 1140 comprises three slots (including slot 1150) forming three arms, each arm having a portion of slotted ring 1145. When an end of seating end portion 1140 having the slotted ring 1145 is being placed in a recess of a retention member (or being removed from within the recess), the three arms can push in towards one another, temporarily reducing the diameter of the seating end portion as it passes through an opening of the retention member and into or out of the recess.

In some embodiments, a locking feature can be provided that prevents expandable grabber 1220 from inadvertently rotating off of an elongated tool. As one non-limiting example, FIG. 12 illustrates an exemplary tool 1200 comprising an expandable grabber 1220 and a first side portion 1230, the first side portion 1230 comprising an expander portion and a threaded portion. First side portion 1230 comprises a spring-loaded component (e.g., ball, ruby ball, metal ball, plastic ball, a ball of any suitable hard material). In some embodiments, component 1235 can remain depressed while expandable grabber 1220 is used until component 1235 aligns with a groove 1222 (which can be a recessed ring, recessed partial ring, an indentation that prevents rotation, etc.). The spring-loaded component 1235 and groove 1222 can advantageously keep the expandable grabber 1220 from unintentionally falling off when turned (e.g., to collapse the expanding portion). The spring-loaded component 1235 and groove 1222 can keep the expandable grabber spinning or positioned in place until it is turned an opposite way (e.g., to re-expand the expanding portion). A spring can be held in place behind the spring-loaded component 1235 with a set screw or press fit pin.

Some contemplated tools of the inventive subject matter can comprise a push/pull mechanism. This can be in addition to, or alternatively to, a turn to activate mechanism described above.

In some aspects, a push/pull mechanism can function similarly to a retractable click pen (e.g., those described in U.S. Pat. No. 3,205,863, owned by Parker Pen Co Ltd.). For example, a tool with a push/pull mechanism can comprise an expander having a spring positioned around at least a portion of the expander, in a section of a housing between an elongate member and an open end of expanding portion. A handle portion (coupled to the housing that contains the expander, elongate member and spring) can comprise a push pin carried by a plunger, and the push button can be biased away from the open end of expanding portion by a second spring. An inner surface of the handle portion can comprise one or more stops affixed thereto. A cam body can be positioned in the handle portion beneath the plunger. The push button can be pressed to drive the plunger and cam body down the handle until the top of the top of the cam body drops beneath a bottom edge of the stops. The first spring can be configured to keep the cam body against the plunger, and the cam body can mate with the plunger at an angle such that the cam body rotates (while plunger does not rotate), for example, when the press button is released or when the press button is pressed down, until it strikes at least one or a wall of a plunger and a stop member.

In some aspects, a push or pull mechanism can comprise a protruding ring (e.g., an o-ring) positioned on an elongate member, and the protruding ring can engage different grooves along an adjuster's inner diameter. In some embodiments, a dental tool is provided comprising a handle, an elongate member coupled to the handle, the elongate member having a first side portion, wherein the first side portion comprises a protruding ring, and an expander having a tapered portion, an expandable grabber having an outer surface, an inner surface, a first end, a second end, and an opening between the first end and second end, wherein the opening comprises a first recessed groove and a second recessed groove, wherein the opening of the expandable grabber is sized and dimensioned to receive a portion of the elongate member having the protruding ring and the expander, and wherein the expandable grabber is configured to be pulled away from handle and pushed towards the handle, wherein the protruding ring is configured to be seated in the first recessed groove before the expandable grabber is pulled away from handle, and wherein the protruding ring is configured to be seated in the second recessed groove after the expandable grabber is pulled away from the handle.

In some aspects, a diameter of the first end of the opening can be adjusted based on a push or pull of the expandable grabber relative to the handle. In some aspects, the opening can comprise a non-recessed portion between the first recessed groove and the second recessed groove, and wherein the non-recessed portion of the opening has a smaller diameter than each of the first recessed groove and the second recessed groove. In some aspects, the protruding ring can be configured to repeatedly compress and return to its original shape. In some aspects, the protruding ring can comprise an o-ring seated in a recessed groove of the elongate member. In some aspects, the protruding ring can be fixed. In some aspects, the protruding ring can be removable.

An exemplary dental tool comprising push or pull mechanism is illustrated in FIGS. 13A-13C. Tool 1300 comprises a handle 1350, which is similar to handle 1105, and an elongate member 130 comprising a first side portion having an expander 1315 and a second side portion (here, positioned in handle 1350, but can be positioned outside of handle 1350 when used). Elongate member 1310 (e.g., a first side portion of elongate member 1310) can comprise a stopper 1312 and a protruding ring (e.g., o-ring 1330). O-ring 1330 can be positioned between expander 1310 and stopper 1312. An expandable grabber having an adjuster 1320, expanding portion 1325, and a through opening can be positioned around expander 1315 and o-ring 1330. The expandable grabber can be pushed in (towards stopper 1312) or pulled out (away from stopper 1312) to adjust a position of a tapered end of expander 1315 relative to an open end of expanding portion 1325, thereby adjusting the diameter or width of open end of expanding portion 1325. An opening, which can be defined by an inner surface of adjuster 1320, can comprise a set of recessed grooves 1322 (e.g., 1, 2, 3 or more recessed grooves) that are sized and dimensioned to receive o-ring 1330. The o-ring could be one or more of elastic and compressible (e.g., configured to compress such that the ring has a thickness that is at least 5%, at least 10%, at least 15% or at least 20% or more smaller than in an expanded state and return to the expanded state). Thus, the o-ring can be configured to repeatedly compress to fit in an area between recessed grooves 1322 (where the opening of expandable grabber has a smaller diameter than portions of the opening with the recessed grooves) while the expandable grabber is being pushed in or pulled out. When seated in a recessed groove (before or after an adjustment), the o-ring could expand back to its original shape. Stopper 1312 can prevent the expandable grabber from being pushed in beyond a predetermined point where an open end of adjuster contacts stopper 1312.

Thus, specific dental tools, components thereof, and related methods have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

As used herein, and unless the context dictates otherwise, the term “coupled to” is intended to include both direct coupling (in which two elements that are coupled to each other contact each other) and indirect coupling (in which at least one additional element is located between the two elements).

The recitation of ranges of values herein is merely intended to serve as a shorthand method of referring individually to each separate value falling within the range, and including the endpoints. Unless otherwise indicated herein, each individual value is incorporated into the specification as if it were individually recited herein.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “assembly,” “mechanism,” “element,” “device,” and the like may not be a substitute for the word “means.” As such, no claim element is to be construed as a means plus function unless the element is expressly recited using the phrase “means for.”

Various modifications to the embodiments described herein will be readily apparent to those skilled in the art, and the general principles described herein can be applied to other embodiments without departing from the spirit or scope of the claims. Thus, it is understood that the scope of the claims fully encompasses other embodiments that may become obvious to those skilled in the art and that the scope of the claims are accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A dental tool, comprising:
an elongate member having a main body portion, and an expander portion;
an expandable grabber including an opening sized and dimensioned to receive a portion of the elongate member including the expander portion; and
an adjustment mechanism coupled to the elongate member and the expandable grabber, the adjustment mechanism configured to adjust a position of the expandable grabber relative to the elongate member to adjust a diameter of at least a portion of the opening.

2. The dental tool of claim 1, wherein the expander portion includes an at least partially tapered end.

3. The dental tool of claim 1, wherein the expander portion is removably coupled to the main body portion.

4. The dental tool of claim 1, wherein the adjustment mechanism comprises a first threaded portion and second threaded portion complimentary to the first threaded portion, wherein the elongate member comprises the first threaded portion, wherein the expandable grabber comprises the second threaded portion, and wherein the adjustment mechanism is configured to adjust the position of the expandable grabber relative to the elongate member by a rotation of the expandable grabber relative to the elongate member.

5. The dental tool of claim 1, wherein the expandable grabber comprises a first portion and a second portion, wherein the first portion has a first internal width and is sized and dimensioned to receive at least a portion of the expander portion, wherein the second portion has a second internal width and is sized and dimensioned to receive a portion of the elongate member having a first threaded portion, and wherein the first width is smaller than the second width.

6. The dental tool of claim 5, wherein the expandable grabber further comprises a third portion having a third internal width that is larger than each of the first width and the second width, and an internal stop between the second portion and the third portion that limits an adjustment of the position of the expandable grabber relative to the elongate member.

7. The dental tool of claim 1, further comprising an abutment driver removably coupled to the elongate member.

8. The dental tool of claim 7, further comprising a handle component having a recess sized and dimensioned to receive at least a portion of the abutment driver.

9. The dental tool of claim 1, wherein the elongate member has a first end and a second end, wherein the first end comprises an at least partially tapered end, and wherein the second end comprises a threaded portion.

10. The dental tool of claim 9, further comprising an abutment driver comprising a threaded recess configured to engage the threaded portion of the second end.

11. The dental tool of claim 9, further comprising a handle component having a threaded recess configured to engage the threaded portion of the second end.

12. A dental tool, comprising:
an elongate member having a first outer surface, a first end and a second end, wherein the first outer surface includes a first threaded portion;
an expandable grabber having a second outer surface, an inner surface, a third end, a fourth end, and an opening between the third end and the fourth end, wherein the inner surface comprises a second threaded portion complementary to the first threaded portion of the elongate member;
an expander forming the first end of the elongate member and comprising a tapered portion;
wherein the opening of the expandable grabber is sized and dimensioned to receive a portion of the elongate member having the first threaded portion and the expander such that the first threaded portion and the second threaded portion are configured to adjustably engage one another; and
wherein an adjustment of the second threaded portion relative to the first threaded portion adjusts a position of the expander relative to the first end of the expandable grabber, and a width of the third end of the expandable grabber.

13. The dental tool of claim 12, wherein the expander portion is removably coupled to a main body portion of the elongate member.

14. The dental tool of claim 12, wherein the expandable grabber comprises a first portion and a second portion, wherein the first portion has a first internal width and is sized and dimensioned to receive at least a portion of the expander, wherein the second portion has a second internal width and is sized and dimensioned to receive a portion of the elongate member having the first threaded portion, and wherein the first width is smaller than the second width.

15. The dental tool of claim 14, wherein the expandable grabber further comprises a third portion having a third internal width that is larger than each of the first width and the second width, and an internal stop between the second portion and the third portion that limits an adjustment of a position of the expandable grabber relative to the elongate member.

16. The dental tool of claim 12, wherein the second end of the elongate member comprises an insertion tool end, and wherein the elongate member comprises a polygonal handle engaging portion between the first end and the second end.

17. The dental tool of claim 16, wherein the insertion tool end is slotted and comprises a slotted ring-shaped projection.

18. The dental tool of claim 16, further comprising a handle component having a first open end and a cavity sized and dimensioned to receive at least a portion of the handle engaging portion and the insertion tool end.

19. The dental tool of claim 18, wherein cavity is sized and dimensioned to receive at least a portion of the handle engaging portion and the expander.

20. The dental tool of claim 18, wherein at least one of the first open end and a portion of the cavity comprises a hexagonal shape.

21. A dental tool, comprising:
a handle;
an elongate member coupled to the handle, the elongate member having a first side portion, wherein the first side portion comprises a protruding ring, and an expander having a tapered portion;
an expandable grabber having an outer surface, an inner surface, a first end, a second end, and an opening between the first end and second end, wherein the opening comprises a first recessed groove and a second recessed groove;
wherein the opening of the expandable grabber is sized and dimensioned to receive a portion of the elongate member having the protruding ring and the expander; and
wherein the expandable grabber is configured to be pulled away from handle and pushed towards the handle, wherein the protruding ring is configured to be seated in the first recessed groove before the expandable grabber is pulled away from handle, and wherein the protruding ring is configured to be seated in the second recessed groove after the expandable grabber is pulled away from the handle.

22. The dental tool of claim 21, wherein a diameter of the first end of the opening is adjusted based on a push or pull of the expandable grabber relative to the handle.

23. The dental tool of claim 21, wherein the opening comprises a non-recessed portion between the first recessed groove and the second recessed groove, and wherein the non-recessed portion of the opening has a smaller diameter than each of the first recessed groove and the second recessed groove.

24. The dental tool of claim 21, wherein the protruding ring is configured to repeatedly compress and return to its original shape.

25. The dental tool of claim 21, wherein the protruding ring comprises an o-ring.
